(19) United States
(12) Patent Application Publication
(10) Pub. No.: US 2006/0024114 A1
(43) Pub. Date: Feb. 2, 2006

(54) Printer assembly and method of using the same

(75) Inventors: Roy Patrick Lyman, Coventry, RI (US); Stephen A. Petersen, Lincoln, RI (US); Richard James Preliasco, North Kingstown, RI (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: ZIH CORP.

(21) Appl. No.: 10/901,883

(22) Filed: Jul. 29, 2004

(51) Int. Cl. B41J 15/02

(52) U.S. Cl. 400/613

(57) ABSTRACT

A printer assembly for dispensing a printer media and printing on the printer media as it is dispensed. The printer assembly includes a housing with a container portion and a lid portion, and a latching mechanism configured to coordinate latching, unlatching and biasing of the lid with locking and unlocking of the printer media supply from a media supply assembly. The latching mechanism may be configured to urge the lid portion away from the container portion when the lid portion is unlatched. The latching mechanism can include a locking surface that is configured to engage a locking surface on relatively movable media support members, restraining relative movement of the media support members and locking down the media supply therein when the latching the lid portion closed. The locking surface is positioned external to opposing, relatively movable surfaces of the media support members enabling a compact assembly for hand held printers.

### BACKGROUND OF THE INVENTION

1. Field of the Invention

The present invention involves the use of latching mechanisms to secure housings on printers, and more particularly to the use of latching mechanisms on handheld printers.

2. Description of Related Art

Desktop printers typically require some type of a media supply (e.g., paper or labels) from which media is drawn and dispensed against a print head. The print head prints on the media (e.g., with ink, toner or heat) as it is passes against the print head. Eventually, after a certain amount of printing, the media supply is exhausted and needs to be replaced with a fresh media supply. Replacement of the media supply typically involves opening a housing of the desktop printer by unlocking one or more latching mechanisms, at which point a tray of the housing is released to allow access to the media supply of a media dispenser. The user can then refill or replace the media in the media dispenser, such as by placing a fresh stack of paper in the tray.

In handheld printers, size constraints typically dictate that the supply of printer media be more compact. For this purpose, rolls of media are often employed. Rolls of media typically need to be positioned with respect to the print head. U.S. Pat. No. 6,609,844 (“the '844 patent), for example, discloses a portable printer 10 having an automatic print alignment. The portable printer includes a housing 12 with an upper housing section 12a which mates with a lower housing section 12b, and a cover 14 for a compartment 16 in the printer which receives a roll of paper or label stock, as shown in FIGS. 1 and 2 of the '844 patent. The roll 15 is made of thermally sensitive paper or label stock that is pulled upwards by a platen roller 24 over a print head 33 as it prints on the paper or label stock.

Placement and replacement of the roll is facilitated by a centering mechanism 36 that ensures that each new roll is centered with regard to the print head, regardless of the width of the roll, as shown in FIGS. 3 and 4 of the '844 patent. The centering mechanism includes two spindles 38 in the compartment for engaging the roll's tubular core and a rack and pinion assembly that enables movement of the spindles with respect to a center position. The rack and pinion assembly includes two racks 40a and 40b each with teeth engaging the teeth 42a of a common pinion or gear 42 and each supporting one of the spindles. An extension spring 56 has one end attached to rack 40a and applies tension on the rack 40a directly and on the rack 40b through the pinion, thereby drawing the spindles together to hold a roll of printer media when placed between the spindles.

A locking mechanism is provided to lock the centering mechanism from substantial movement when the cover is latched closed by a latch member 68. A rack lock 86 of the mechanism has a cylindrical shape with an open end 86a and projections 87 for engaging additional pinion teeth 54. The rack lock is mounted on a plate 90 having two notches 92 mounted to slide along two tracks 93 extending downwardly from a frame 30 of the printer. This positioning allows the rack lock to engage the pinion teeth with only a slight forward movement.

A compression spring 96 biases the rack lock away from the pinion teeth. However, the bias of the compression spring can be overcome by movement of the latch member to the closed position which depresses a lever 110 and turns a shaft 102 supporting the lever. Turning of the shaft pushes the rack lock forward against the bias of the compression spring until the rack lock engages the pinion, halting movement of the pinion, the racks and the spindle members. Latching the cover of the printer, therefore, locks the media roll in a centered position with respect to the print head to facilitate printing. Although the printer of the '844 patent advantageously centers and locks a media roll in place for a hand held printer, additional improvements in the compactness and simplicity of the operation of hand held printers is always desirable.

Therefore, it would be advantageous to have a printer that has a simplified mechanism for holding, enclosing and exchanging media. It would be further advantageous if the simplified mechanism were also compact so as to facilitate its use in a hand held printer.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a perspective view of a printer of one embodiment of the present invention;

FIG. 2 is a perspective view of the printer of FIG. 1 with a media cover in an open position;

FIG. 3 is a perspective view of a wireless card processor cover and main circuit board of the printer of FIG. 1;

FIG. 4 is a perspective view of contents of a base portion of the printer of FIG. 1;

FIG. 5 is an exploded view of a print head, drive and latching assemblies of the printer of FIG. 1;

FIG. 6 is a perspective view of a media support assembly of the printer of FIG. 1;

FIG. 7 is a perspective view of the media support assembly of FIG. 6;

FIG. 8 is another perspective view of the media support assembly of FIG. 6 containing a roll of media;

FIG. 9 is an exploded view of the media support assembly of FIG. 6;

FIG. 10 is a perspective view of the print head assembly of FIG. 5;

FIG. 11 is a sectional view of the print head assembly of FIG. 5;

FIG. 12 is a perspective view of an interrupt sensor mounted on the main circuit board and a latch member of the printer of FIG. 1;

FIG. 13 is a partial view of a latch assembly of the printer of FIG. 1;

FIG. 14 is a perspective view of the print head assembly of FIG. 5 and the latch assembly of FIG. 13; and

FIG. 15 is an elevation view of the latch member of FIG. 12.

### DETAILED DESCRIPTION OF THE INVENTION

The present invention addresses the above needs and achieves other advantages by providing a printer assembly for dispensing a printer media and printing on the printer media as it is dispensed. Generally, the printer assembly includes a housing with a container portion and a lid portion, and a latching mechanism configured to coordinate latching, unlatching and biasing of the lid with locking and unlocking of the printer media supply from a media supply assembly. For instance, the latching mechanism may be configured to urge the lid portion away from the container portion when the lid portion is unlatched, thereby enabling one-handed opening of the lid portion to reveal the media supply. In addition, the latching mechanism can include a locking surface that is configured to engage a locking surface on one or both of a pair of relatively movable media support members to restrain relative movement of the media support members and lock into position the media supply therein. Preferably, the latching mechanism latches the lid portion closed at the same time as locking the media support members. Advantageously, the locking surface is positioned external to opposing, relatively movable surfaces of the media support members enabling a compact assembly for hand held printers. Other aspects of the printer assembly include the use of an integrally constructed platen bar and gear for improved alignment and robustness and the use of two or more pinions to coordinate movement of the media support members for self-centering of the media supply.

In one embodiment, the present invention includes a printer assembly for dispensing a printer media from a printer media supply and printing on the printer media as it is dispensed. Included in the printer assembly is a housing having a container portion and a lid portion. The lid portion is configured to mate with the container portion in a closed position so as to at least partially enclose the printer media. A pair of media support members is configured to grip the printer media supply when the printer media supply is positioned between the media support members. A printer media dispenser is configured to dispense the printer media from the printer media supply when the printer media supply is positioned therein. The printer assembly also includes a print head for printing on the printer media supply as the media supply is dispensed. Each of a pair of media support arms supports a respective one of the pair of media support members. The media support arms are movable relative to each other so as to move the pair of media support members together to grip the printer media supply. One of the media support arms has a locking surface positioned external to opposing relatively movable surfaces of the media support arms. A latch mechanism is supported by the housing, includes a locking surface and is movable to at least partially secure the lid in the closed position. The latch mechanism is configured to engage the locking surfaces upon moving to secure the lid in the closed position. Engagement of the locking surfaces restricts relative movement of the media support arms and media support members so as to secure the printer media between the media support members when the lid is secured.

The printer assembly may further include at least one pinion positioned between rack surfaces on the media support arms and configured to couple movement of the media support arms for self-centering of the media supply. Preferably, the locking surface on the support arm is positioned on an opposite side of the support arm from the rack for a compact locking arrangement.

In another aspect, the latch mechanism includes a latch member and a locking plate. The locking plate supports the locking surface of the latch mechanism and is configured to move relative to the latch member when engaging the locking surface of the support arm. The latch member can include a latch hook that is configured to engage a flange on the lid portion so as to secure the lid portion in a closed position. Movement of the locking plate for engagement is caused by a cam surface defined on the locking plate that interfaces the latching member. Additionally, the latching member may include locking plate guide(s) for guiding movement of the locking plate.

In one example, the cam surface is defined by an engagement opening in the locking plate in which a tracking peg of the latch member slides. Movement of the latch member into the locking position moves the tracking peg from a straight portion of the engagement opening to an angled portion of the engagement opening. Movement into the angled portion by the tracking peg slides the locking surface of the locking plate into engagement with the locking surface of the support member.

In still another aspect, the locking surfaces include concave and convex teeth to facilitate locking engagement.

In another embodiment, the present invention includes a printer assembly for dispensing a printer media and printing on the printer media as it is dispensed. The printer assembly includes a housing having a container portion and a lid portion. The container and lid portions are configured to mate in a closed position so as to enclose the printer media. A lid biasing device of the printer is configured to partially urge the lid portion away from the container portion. A latching mechanism is configured to additionally urge the lid portion away from the container portion when activated. The combined urging of the lid biasing device and the latching mechanism cause the lid to move to an open position, revealing the printer media.

The printer assembly can also include a printer media dispenser, a print head and a platen. The printer media dispenser is configured to dispense the printer media while the print head is configured to print on the printer media as it is dispensed. The platen holds the printer media against the print head to facilitate printing under the urging of a print biasing device. In another aspect, the platen is supported by the lid portion so that the print biasing device also biases the lid portion closed. In this aspect, the latching mechanism and biasing device are configured to overcome the bias of the print biasing device and/or the weight of the lid and cause the lid to move to the open position.

The lid portion may be rotatable with respect to the container portion, in which case the lid biasing device and the latching mechanism urge the lid portion to rotate into the open position. For example, the lid portion may be connected to the container portion with a hinge, wherein the lid biasing device is a torsion spring mounted on the hinge.

A cam surface may be included in the latching mechanism, wherein the cam surface is configured to urge the lid portion away from the container portion. For example, the cam surface can be an outwardly directed, sloped surface configured to intersect and urge the lid portion away from the container portion.

In still another aspect, the latching mechanism may be further configured to engage the lid portion and lock the lid portion closed. For example, the latching mechanism can include a movable latching member having a latch hook. Configured to receive the latch hook is a flange of the lid portion, wherein the latch hook is engaged to lock the lid portion in the closed position. The latching member is also moveable to disengage the latch hook from the flange of the lid portion and allow movement of the lid portion away from the closed position. A sensor may also be employed to sense when the latching member has been moved to the open position, wherein information from the sensor is used to shut down printing.

In another embodiment, the present invention includes a media support assembly for centering and holding a media supply. A pair of media support members of the media support assembly is configured to grip the printer media supply when the printer media supply is positioned between the media support members. A printer media dispenser is configured to dispense the printer media supply when held by the media support members. Each of a pair of media support arms supports a respective one of the pair of media support members. The media support arms are movable with respect to each other so as to urge the pair of media support members together to grip the media printer supply. At least two pinions and typically three pinions are mounted between the support arms. A first one of the pinions meshes with a rack surface on one of the media support arms. A second one of the pinions meshes with a rack surface of the other one of the media support arms. In some embodiments, a third pinion meshes with the first one of the pinions and a second one of the pinions. Together, the pinions and rack surfaces couple the motion of the support arms and the media support members so that the media support members are self-centering when gripping the media supply.

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

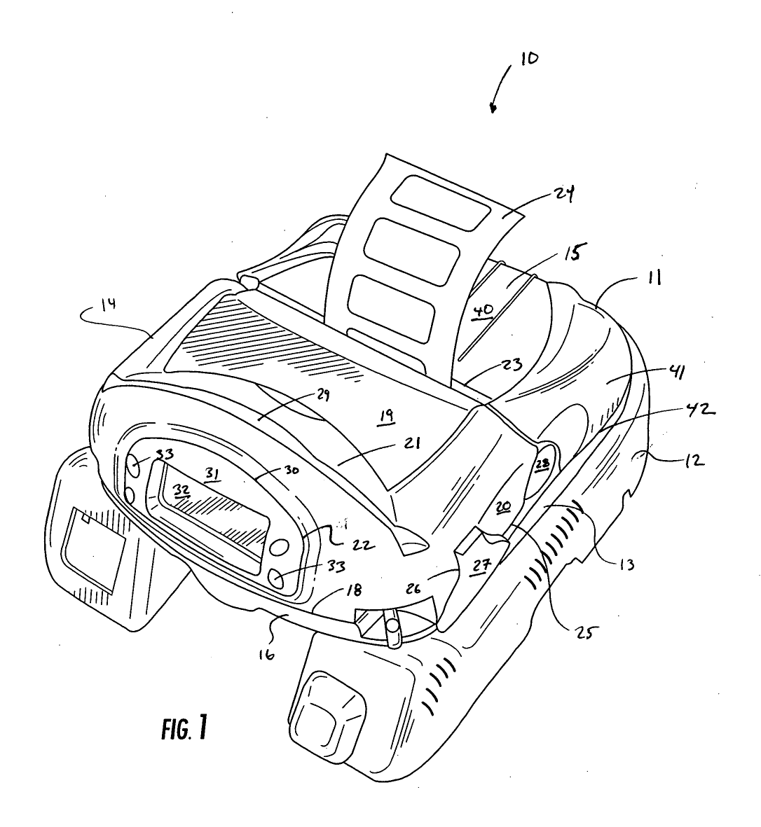

A handheld printer 10 of one embodiment of the present invention is shown in FIGS. 1-13. Generally, the printer includes a rounded, rectangular housing 11 that can be supported within a cradle 12, as shown in FIG. 1. The housing has three main sub-portions, including a base 13, a wireless card processor cover 14 and a media supply lid or cover 15.

Various aspects of the printer illustrated in FIG. 1 are described in greater detail in the following patent applications which have been filed concurrently herewith and are hereby incorporated herein in their entirety by reference, including:

U.S. Provisional Application No. ______ to Horrocks, et al., filed on Jul. 29, 2004 and entitled SYSTEM AND METHOD FOR PROVIDING A PORTABLE PRINTER CAPABLE OF ALTERING THE ORIENTATION OF INFORMATION DISPLAY ON AN ASSOCIATED PRINTER DISPLAY;

U.S. Provisional Application No. ______ to Klein, et al., filed on Jul. 29, 2004 and entitled INTERCHANGEABLE MODULE FOR A PORTABLE PRINTER AND SYSTEM FOR OPERATING THE SAME;

U.S. Nonprovisional application Ser. No. ______ to Lyman, et al., filed on Jul. 29,2004 and entitled DOCKING STATION AND ASSOCIATED METHOD FOR DOCKING A PORTABLE PRINTER;

U.S. Nonprovisional application Ser. No. ______ to Beck, et al., filed on Jul. 29, 2004 and entitled UNIVERSAL CARD READER APPARATUS AND METHOD; and

U.S. Nonprovisional application Ser. No. ______ to Beck, et al., filed on Jul. 29, 2004 and entitled PRINTER CABLE AND ASSOCIATED STRAIN RELIEF COLLAR FOR CREATING A RUGGEDIZED CONNECTION FOR AN ELECTRICAL TERMINAL OF A PRINTER AND ASSOCIATED METHODS THEREFOR.

The base 13 has a rectangular shape with a wall structure 16 extending upwards from a bottom surface 17 to support and contain various electronic and mechanical assemblies of the printer 10. The wall structure 16 ends in a free edge 18 that extends continuously around the rectangular shape of the base 13 and is configured to mate with the card processor cover 14 and the media supply cover 15.

The wireless card processor cover 14 includes a deck portion 19, a pair of sidewalls 20, an information card receiving portion or communications module 21 and a display portion 22. The deck portion 19 is a relatively planar surface that extends between the pair of sidewalls 20 and defines one edge of a media dispensing opening 23 through which a strip of media 24 extends, as shown in FIG. 1. Each of the sidewalls 20 includes a free edge 25 that is configured to mate with the media supply cover 15 and with the free edge 18 of the base wall structure 16.

The wall structure 16 of the base 13 and one of the sidewalls 20 together define an input/output (I/O) opening 26 for receiving and connecting various input and output devices. Covering the I/O opening is a flexible, resilient I/O cap or cover 27. A portion of the free edge 25 of the same one of the sidewalls 20 defining the I/O opening 26 has an arc shape to provide clearance (along with an arc shape defined by the media supply cover 15 and a semi-circle defined by the free edge 18 of the base wall structure 16) for a latch button 28 used to open the media supply cover 15, as will be described in more detail below.

Abutting the deck portion 19 is the information card receiving portion or communication module 21. In the illustrated embodiment, the information card receiving portion 21 extends upwardly to a peak and downwardly transitioning into the display portion 22. It should be noted that the information card receiving portion could optionally include any type of communication module, such as an optical scanner, RF receiver/transmitter, RFID encoder/decoder, magnetic strip reader, smart card reader, etc.

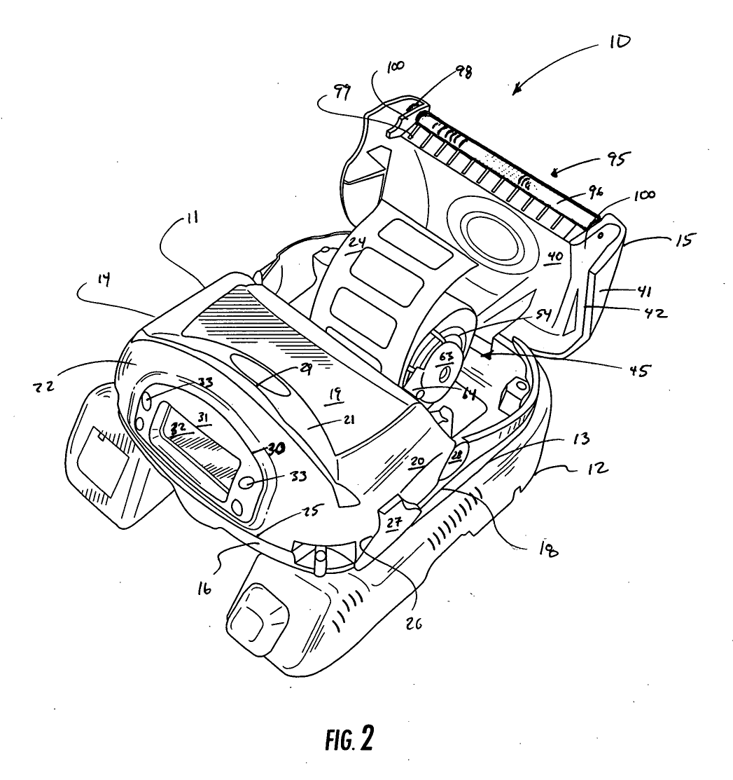

Defined at the peak of the information card receiving portion 21 is a card receiving slot 29 that is sized and shaped to allow a magnetic strip information card (such as a credit card) to be “swiped” therethrough for reading and decoding of information recorded thereon. Other types of information card could also be extended through the card receiving slot 29 for reading, including various bar-coded cards or contact and non-contact smart cards. Further, any media, such as envelope, slip of paper, etc., having a magnetic strip or smart card features could be slid and read via the slots. The display portion 22 of the card processor cover 14 defines a display opening 30 through which extends a display unit 31, as shown in FIGS. 1 and 2. The display unit 31 includes a display screen 32 and four buttons 33 that communicate information on operation of the printer 10 and record inputs and selections by the operator.

The media supply cover 15 includes its own deck portion 41 and wall structure 42, as shown in FIGS. 1 and 2. The deck portion 41 is a relatively flat, planar surface that is coextensive with the deck portion 19 of the wireless card processor cover 14. The deck portion 41 defines an edge of the media dispensing opening 23 opposite the edge defined by the deck portion 19 of the wireless card processor cover 14. Optionally, the deck portion may be constructed of a transparent or translucent material to facilitate visibility of the media roll in anticipation of replacement of a spent or nearly spent media roll. A free edge of the wall structure 42 is configured to mate with a portion of the free edge 25 of the sidewalls 20 of the wireless card processor cover 14 and a portion of the free edge 18 of the wall structure 16 of the base 13 to form the closed housing 11 shown in FIG. 1.

Now that the external aspects of the printer 10 of the illustrated embodiment have been described, including the structure of its housing 11, attention will be turned to the contents of the housing, including the various assemblies that enable the printing and card reading functions.

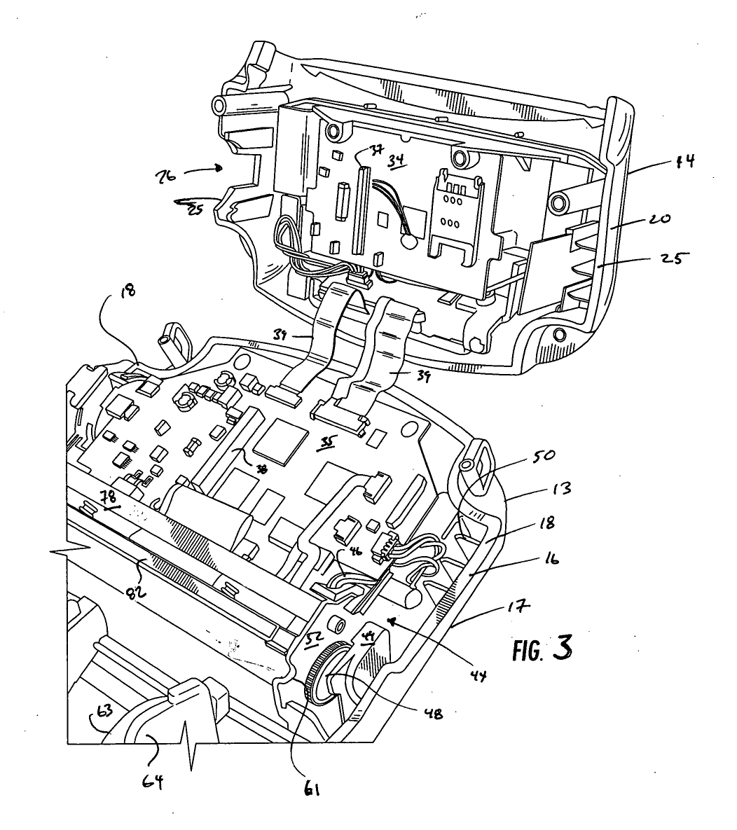

Supported by the wireless card processor cover 14 is a wireless communications and card processing circuit board 34, as shown in FIG. 3. The circuit board 34 is configured to perform communications tasks and includes, for example, one or more of a Wi-Fi 802.11 wireless interface, a Bluetooth wireless radio and a cellular network connection to promote wireless, handheld use. The wireless communications and card processing circuit board 34 is further configured to interface with a smartcard, magnetic card, barcode scanning or other information card reading device (not shown) supported in the wireless card processor cover 14 between the cover and the circuit board 34.

Generally, the wireless communications and card processing circuit board 34 obtains information from the card reading device, processes the data and routes it to a main circuit board 35. Supported on the wireless communications and card processing circuit board 34 is a multiple pin male connector 37 that is configured for insertion into a multiple pin female connector 38 on the main circuit board 35 when the housing 11 is assembled, thereby enabling the aforementioned communication between the two boards. The display unit 31 is also supported by the wireless card processor cover 14 and is connected to the main circuit board 35 by ribbon cables 39 allowing communication between the display unit and the main circuit board.

Hereagain the above description of the wireless card processor cover 14 is somewhat specific to a card reading module. In other embodiments, not shown, the module can be an optical scanner, RF receiver/transmitter, RFID tag encoder/decoder, etc., in which case different components in the module would be used to facilitate its use and communication with the main circuit board 35 of the base 12 described below.

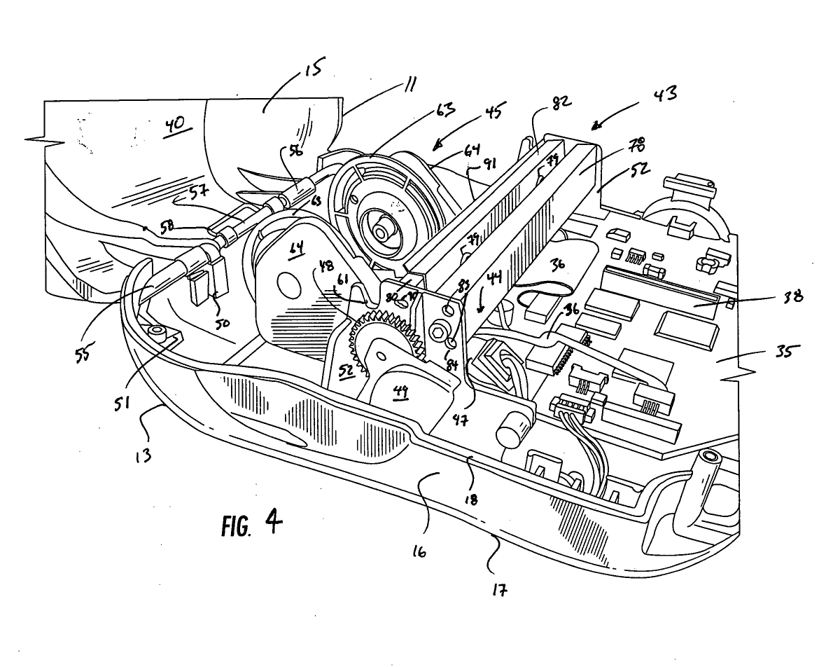

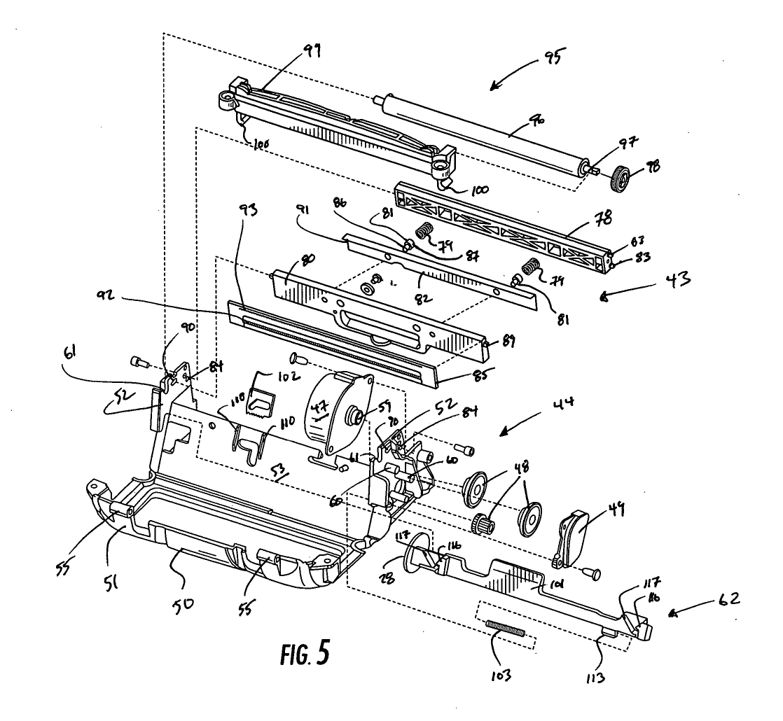

Referring now to FIG. 4, the base 13 of the housing 11 supports the main circuit board 35, a print head assembly 43, a drive assembly 44, a media support assembly 45 and a latch assembly 62. The print head assembly 43, the drive assembly 44, the media support assembly 45 and the latch assembly 62 are each mounted on a frame 50, as shown in FIGS. 4 and 5.

The frame 50 is supported within, and attached to, the base 13 of the housing 11. The frame 50 includes a hinge portion 51, and one or more side flanges 52 and a divider wall 53. The hinge portion 51 typically has a rectangular frame shape with rounded edges so as to fit in the rounded shape in an area of the base 13 housing a media supply roll 54. One or more hinge mounts 55 of the hinge portion 51 are positioned to extend along the free edge 18 of the base wall structure and to allow rotatable mounting of the media supply cover 15 at one edge via its own hinge mounts 56. A shaft 57 extends through the mounts 55, 56 and has mounted thereon a torsion spring 58 which biases the media supply cover 15 into its open position, as shown in FIG. 4.

It should be noted that the second stage opening device could also include other opening mechanisms such as a solenoid, pneumatics, hydraulics or other biasing devices and still fall within the purview of the present invention. The illustrated torsion spring, however, does have the advantage of a light weight and relatively low cost, especially since it is assisted in its first, or initial stage of opening by the latching mechanism.

The side flanges 52 of the frame 50 extend upwards from the base 13 of the housing 11 on the lateral sides of the base. The divider wall 53 extends between the side flanges 52 and generally partitions the base 13 into two portions, one portion having the media support assembly 45 and the other portion containing the main circuit board 35. Both the flanges 52 and the divider wall 53 have structure that provides support for the assemblies 43, 44 and 45, as will be described in more detail below with the description of the assemblies.

The main circuit board 35 includes a processor and other electronic components for controlling printer operation which are not described in greater detail herein for the sake of brevity. A pigtail wire 46 connects the main circuit board 35 to the drive assembly 44 and ribbon cables 36 connect the main circuit board to the print head assembly 43. As mentioned above, the ribbon cables 39 connect the display unit 31 to the main circuit board. These connections enable the main circuit board 35 to communicate with, and control, the print head and drive assemblies 43, 44.

The drive assembly 44 includes a motor 47, several drive gears 48 and a gear cover 49, as shown in FIGS. 4 and 5. The motor 47 is mounted to the inside surface of one of the side flanges 52 and has a drive shaft 59 extending through an opening in the side flange to mesh with the drive gears 48. The drive gears are rotatably mounted on pegs 60 extending from the opposite side of the side flange, and mesh with each other so as to be driven by the motor 47. The gear cover 49 is mounted over a portion of the drive gears 48 so as to protect the drive gears during operation.

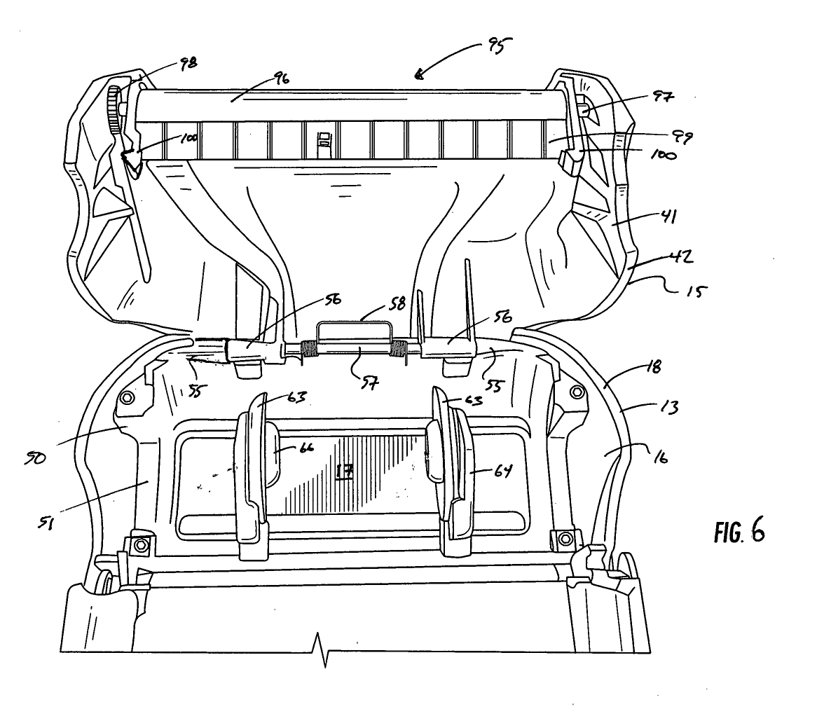

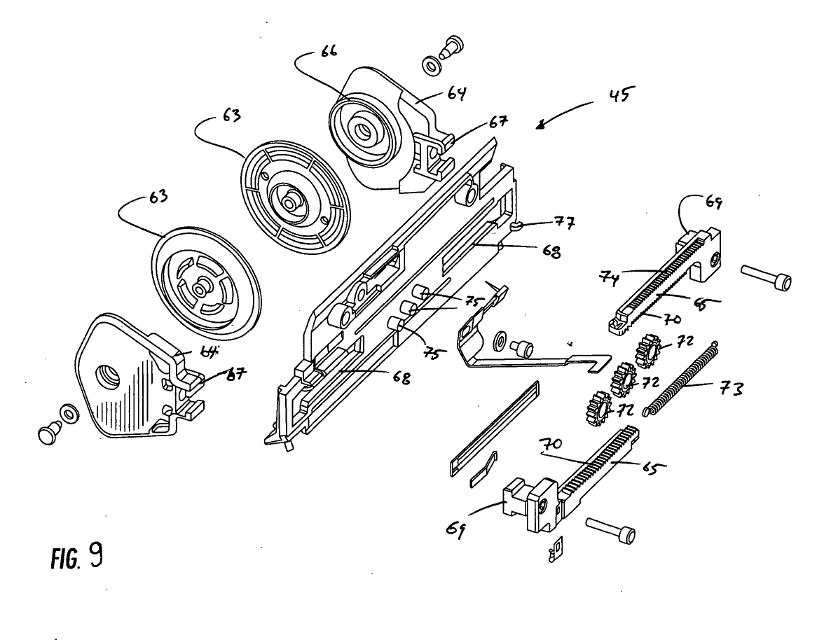

The media support assembly 45 includes a pair of media support discs 63, a pair of disc support flanges 64, a pair of racks 65, two or more pinions 72 and a tension spring 73, as shown in FIGS. 6-9. Each of the media support discs 63 has circular outer edges and a centrally located raised circular portion configured to grip an end of the media supply roll 54, as shown in FIG. 6. The media support discs 63 are supported by the disc support flanges 64 in opposing positions so as to be able to grip the media supply roll 54 when positioned between the media support discs. As shown in FIG. 9, each of the disc support flanges has a circular mounting 66 configured to allow free rotation of the media support discs 63. In addition, each of the disc support flanges 64 also includes a mount 67 that has an internal channel shape that is configured to mate with a T-shaped mounting 69 fixed to a respective one of the racks 65.

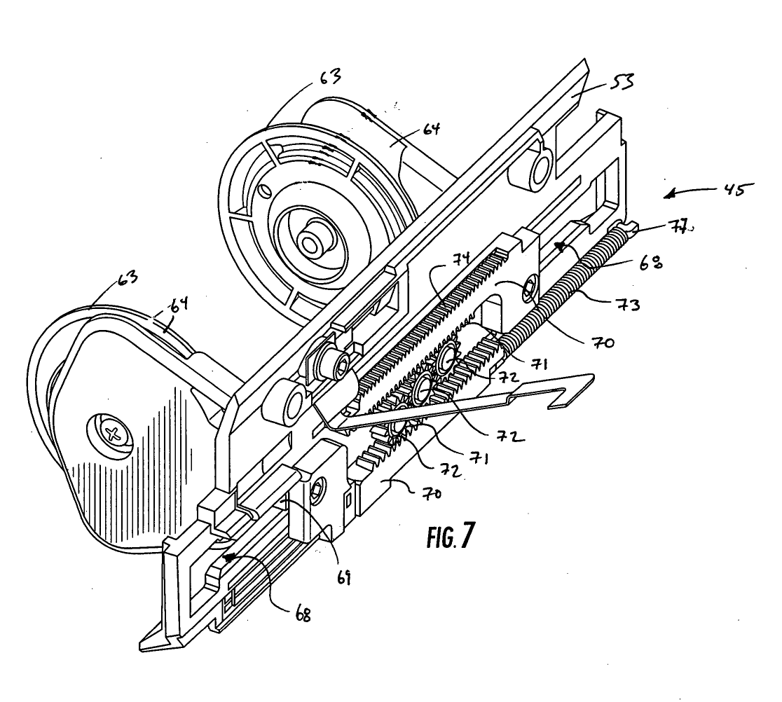

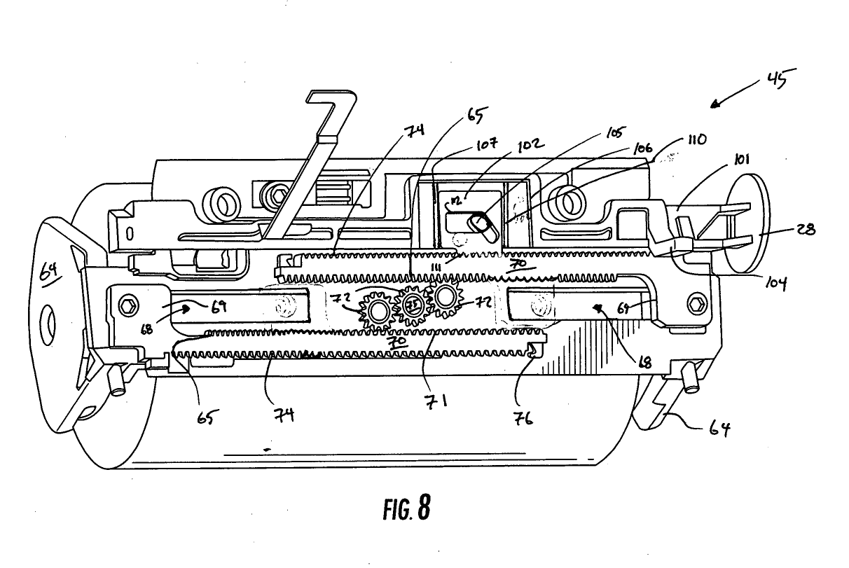

The T-shaped mounting 69 of each of the racks 65 is also configured to fit and slide within a respective one of a pair of guide slots 68 defined by the divider wall 53, as shown in FIGS. 7 and 8. Extending from the T-shaped mounting 69 is a rack arm 70 that has a pinion face 71 that has teeth shaped to mesh with the teeth of one of the pinions 72. The rack arm 70 also includes a locking face 74 positioned opposite the pinion face 71 for interacting with the latch assembly 62 to lock the rack arm in place, as will be described in more detail below.

One rack arm 70 occupies a lower position below the pinions 72 and extends in an opposite direction from the other rack arm which is positioned above the pinions. The pinions 72 are each rotatably mounted on pinion pegs 75 (shown in FIG. 9) extending outwardly from the divider wall 53 and communicate sliding motion between the rack arm 70 of each of racks 65. Each of the racks 65 also includes a spring hook 76 formed at an end opposite the T-shaped mounting 69. Attached to the spring hook 76 of one, or both, of the racks 65 is the tension spring 73 that extends therefrom to an attachment hook 77 formed on the divider wall 53.

The tension spring 73 biases the disc support flanges 64 and media support discs 63 together by exerting tension directly on its one of the racks 65, and indirectly on the other one of the racks through the pinions 72. As shown in FIG. 7, the length of the guide slots of 53 acts as a stop against the racks 65 running into each other and limits the travel of the media support discs 63. This facilitates one-handed insertion of the media supply roll 54 by allowing enough space for the roll to be inserted between the media support discs 63. An additional tension spring 73 may be used, so that both of the racks 65 are directly, and indirectly, biased together.

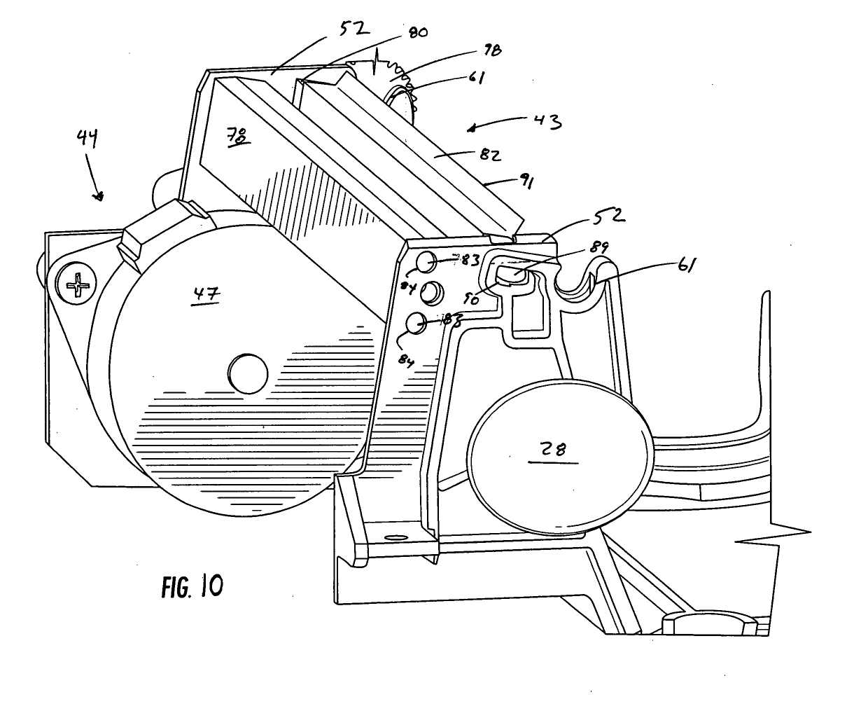

The print head assembly 43 includes a mounting bar 78, one or more springs 79, a heat sink 80, one or more stop screws, bolts or pegs 81, a tear bar 82 and a thermal printing interface 85, as shown in FIG. 5. The mounting bar 78 has an elongate rectangular shape and includes a pair of mounting pegs 83 on its ends. Cutouts in the mounting bar 78 reduce its weight and the elongate shape allows mounting of the mounting bar between the pair of side flanges 52. In particular, each of the side flanges 52 defines a pair of mounting openings 84 sized and positioned to receive the mounting pegs 83 on the ends of the mounting bar 78, as shown in FIG. 10.

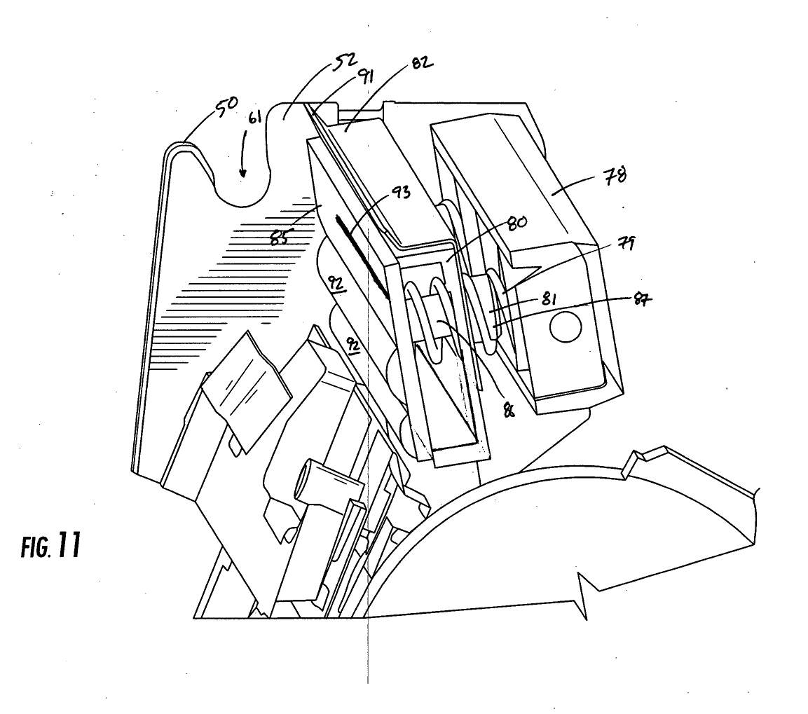

The springs 79 are attached at one end to the mounting bar 78 at spaced positions. The springs 79 are coil springs that extend toward the media support assembly 45, pass through openings in the heat sink 80 and attach at their other ends to the thermal printing interface 85. Extending within the springs 79 are the stop pegs 81, each of which includes a shaft 86 and a head 87. The shaft 86 of each of the stop pegs 81 attaches to the thermal printing interface 85 and extends through the heat sink 80 to the head 87. The head is positioned between the heat sink 80 and the mounting bar 78, as shown in FIG. 11.

Similar to the mounting bar 78, the heat sink 80 has an elongate rectangular shape that extends between the side flanges 52. Also, the heat sink 80 includes one of a pair of elliptical mounting pegs 89 at each of its ends. Defined in the side flanges 52 are slots 90 sized to receive a minor width of each of the elliptical mounting pegs 89. The length of the slots 90 allow sliding of the elliptical mounting pegs 89 therein. Attached to the heat sink 80 and extending therealong are the tear bar 82 and the thermal printing interface 85.

The tear bar 82 is constructed of a sheet of metal bent to conform to an upper corner of the heat sink 80, and includes a serrated tearing edge 91 flared upwards from the upper surface of the heat sink and over an upper edge of the thermal printing interface 85. The thermal printing interface 85 is attached to the heat sink 80 on the side of the media support assembly 45. On its outward surface facing the media support assembly, the thermal printing interface 85 includes a pair of arcuate rider surfaces 92 and a burn line 93. The rider surfaces 92 extend in parallel along the length of the thermal printing interface 85 below the burn line 93 which also extends along the length of the thermal printing interface.

A platen assembly 95 of the printer 10 is shown in FIGS. 5 and 6, and includes a platen bar 96, a platen shaft 97 and a platen gear 98 and is supported by a platen frame 99 of the media supply cover 15. In the illustrated embodiment, the platen bar 96 is an elongate, cylindrical bar that includes a rubber or polymeric coating to facilitate gripping of the strip of media 24. The platen bar 96 extends between a pair of spaced flanges 100 defined on opposite sides of the platen frame 99 near the wall structure 42 of the media supply cover 15. The platen shaft 97 extends from the ends of the platen bar 96 and through corresponding openings defined in the flanges 100 so as to rotatably support the platen bar and shaft. On one end, the platen shaft 97 supports the platen gear 98, which is recessed between the adjacent one of the flanges 100 and the wall structure 42, as shown in FIG. 6.

Preferably, the platen bar 96, platen shaft 97 and platen gear 98 are integrally constructed by being machined from a single piece of relatively rigid metal, such as steel or aluminum. Advantageously, integral construction ensures that the platen gear maintains its orientation during operation, even after the printer 10 has been jarred by a drop or other blow. In addition, use of metal allows the gear to withstand the heat of application of the rubber or polymeric coating on the outer surface of the platen bar 96.

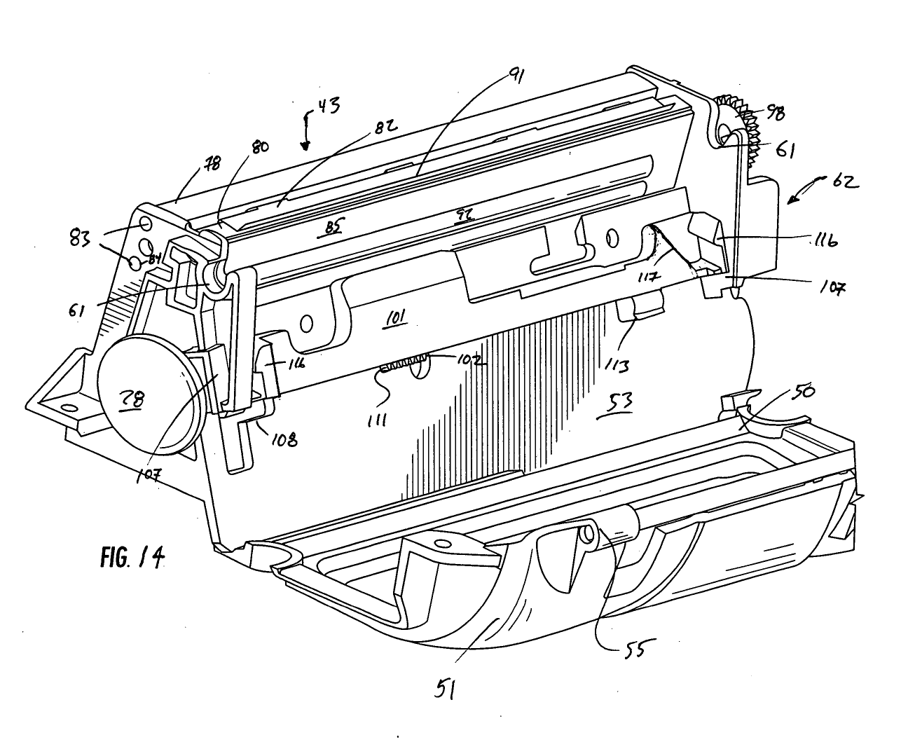

The side flanges 52 of the frame 50 define a pair of journal notches 61 that have a circular inner portion and a flared outer portion, as shown in FIGS. 11 and 14. The journal notches 61 are sized and shaped to receive ends of the platen shaft 97 when the media supply cover 15 is in a closed position.

When the media supply cover 15 is in the closed position, the platen assembly 95 cooperates with the drive assembly 44 and the media support assembly 45 to draw the strip of media 24 across the thermal printing interface 85 of the print head assembly 43 for printing. In particular, when the media supply cover 15 is closed, the platen bar 96 is positioned against the burn line 93 of the thermal printing interface 85 and the platen gear 98 meshes with the top-most one of the drive gears 48. The strip of media 24 extends over the rider surfaces 92 and between the platen bar 96 and the burn line 93. The thermal printing interface 85 is urged against the strip of media 24 and the platen bar 96 by the springs 79.

Advantageously, the thermal printing interface 85 can also shift to compensate for varying thicknesses of the strip of media 24 because of the elliptical mounting pegs 89 on the ends of the supporting heat sink 80 which can slide within the slots 90. This shifting motion is limited, or mediated, by the size of the slots 90 if the forces on the heat sink 80, tear bar 82 and thermal printing interface 85 are large, such as when the strip of media 24 is torn over the tear bar after printing. Optionally, the shifting motion may be limited also by the step pegs 81 dead-ending against the mounting bar 78. Engagement of the platen gear 98 with the drive gears 48 allows the motor 47 to turn the platen bar 96. The compression provided by the springs 79 and the friction of the gripping surface of the platen bar 96 enable the motion of the platen bar to pull the strip of media 24 off of the media supply roll 54.

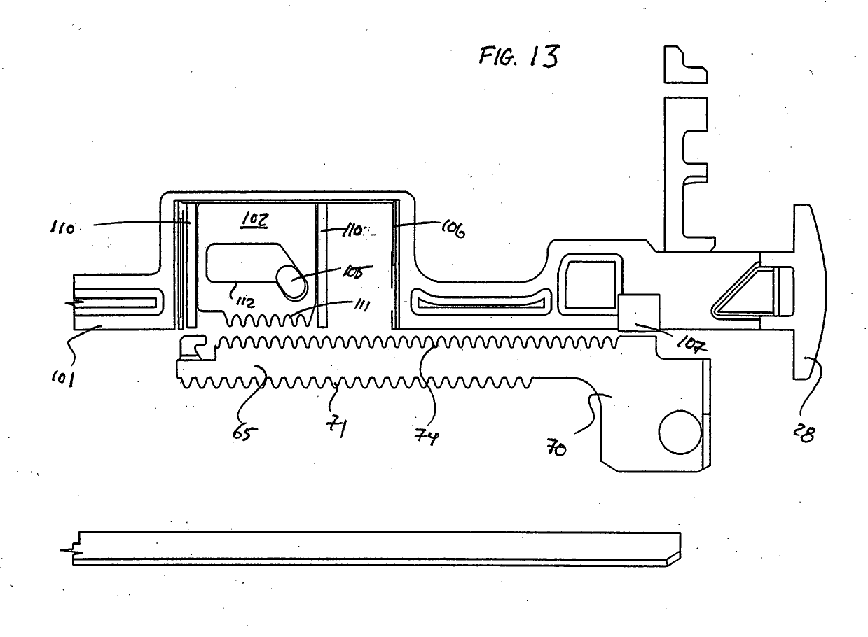

The latch assembly 62 includes a latch member 101, a locking plate 102 and a latch spring 103, as shown in FIG. 5. The latch member 101 has an elongate shape with the latch button 28 extending from one end. The latch member is slidably supported channels 107 that are defined in the side flanges 52 of the frame 50, as shown in FIGS. 13 and 14.

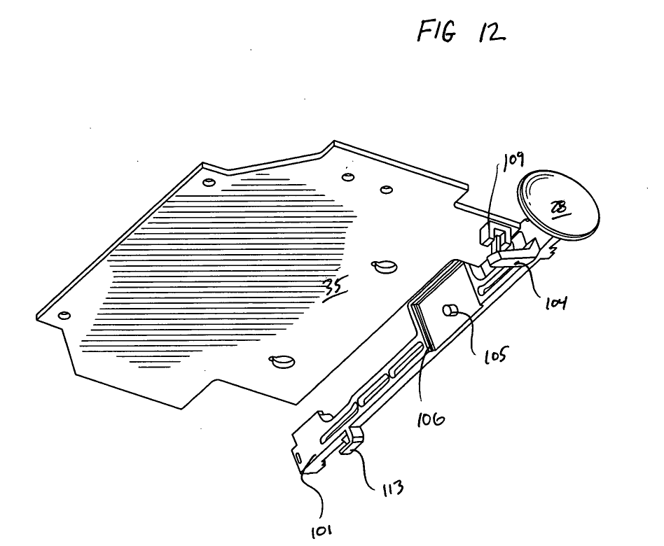

On a side of the latch member 101 facing the divider wall 53, the latch member includes a sensor arm 104 and a tracking peg 105 that is positioned in a rectangular recess 106, as shown in FIG. 12. The sensor arm 104 is positioned at one end of the latch member 101 and extends down through a sensor arm opening 108 defined in the divider wall 53 and upward into a U-shaped interrupt sensor 109. The U-shaped interrupt sensor is preferably an optical sensor that is supported by the main circuit board 35 and communicates interruption when the sensor arm is positioned in the arms of the sensor.

The rectangular recess 106 is sized to extend around a pair of vertically oriented locking plate guides 110 that extend outward from the divider wall 53, as shown in FIG. 5. The locking plate guides 110 are parallel and spaced apart from each other about the same distance as the width of the locking plate 102, as shown in FIG. 13. The locking plate 102 has a thin, rectangular shape and includes a row of teeth 111 extending along one edge. An engagement opening 112 defined in the locking plate includes an angled portion and a straight portion and is sized to extend around the tracking peg 105. The tracking peg extends outward from the base of the rectangular recess 106 and has an elongate shape with rounded ends that is sized to slide within the engagement opening 112.

As assembled, the latch member 101 extends closely along the divider wall 53 and the rectangular recess 106 is positioned over the locking plate guides 110. The locking plate 102 extends between the locking plate guides and the tracking peg 105 extends into the engagement opening 112. The shape of the engagement opening causes the teeth 111 of the locking plate 102 to be urged into and out of engagement with teeth on the locking face 74 of the adjacent rack arm 70. In particular, sliding of the latch member 101 (by depressing of latch button 28) moves the tracking peg 105 within the engagement opening 112 from the angled portion (as shown in FIG. 13) to the straight portion.

In the angled portion of the engagement opening, the locking plate 102 is positioned at the top of the locking plate guides 110 and adjacent the edge of the rectangular recess 106. In the straight portion, the locking plate is positioned at the bottom of the locking plate guides 110 and the teeth 111 of the locking plate 102 engage the teeth of the locking face 74. Notably, the teeth 111 of the locking plate 102 have a concavely curved shape so that they easily capture and urge themselves into firm engagement with the convexly curved shape of the teeth of the locking face, as shown in FIG. 8. It should be noted that the concavity and convexity of the teeth could be reversed and accomplish the same objective of a firm, positive fit.

Referring again to FIG. 12, the latch member 101 includes a spring flange 113 for engaging the latch spring 103. The latch spring is preferably a compression spring and is positioned between the spring flange 113 and the adjacent one of the side flanges 52 so that the latch member is biased to urge the button 28 outwards, i.e., in the left-handed direction on FIG. 5. Engagement of the latch member with the flanges 100 when the media supply cover is closed, as will be described in more detail below, holds the latch member short of its left-most position wherein the locking plate 102 is biased toward the engaged or locking position. In this position, the locking plate 102 inhibits movement of the racks 65 which, in turn, locks the media support discs 63 about the media supply roll 54. Opening of the lid 15 disengages the flanges 100 and the latch member 101, allowing the latch member to be biased to the outermost position, which disengages the locking plate 102 from the locking face 74.

Advantageously, engaging the rack arm 70 instead of engaging one of the pinions 72 allows for a compact locking mechanism because the rack arm can be locked external to the interface between the pinion face 71 and the pinions 72. Compactness of the locking mechanism is also derived from the positioning of the locking face 74 opposite the pinion face 71 and the recessed positioning of the locking plate 102 within the latch member 101. In addition, the direct engagement of the rack arm 70 by the locking plate 102 (as opposed to some type of engagement of one of the pinions 72) reduces complexity of the mechanism for robust performance.

It should be noted that the locking face 74 and the locking plate 102 could have interfaces other than teeth to allow for releasable engagement, such as adhesives, magnets or hook and loop connections. Also, it should be noted that the locking plate 102 could be positioned to engage a lateral, or other, surface of the of the rack arm 70. In addition, the locking plate 102 could engage the rack arm of the lower one of the racks 65. Further, the row of teeth 111 could be positioned on various shapes and sizes of members in lieu of the locking plate, that are cam activated by motion of the latch member 101, or even be supported directly on the latch member. For instance, the latch member may itself have cam surfaces so that it moves into and out of contact with the locking face 74 along with motion used to unlatch the media supply cover 15, and still be within the purview of the present invention.

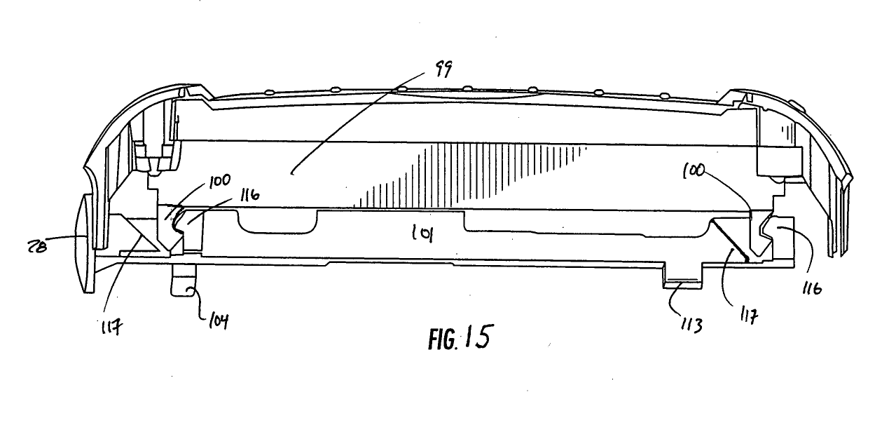

In addition to locking and unlocking the media support assembly 45, the latch assembly is configured to enable one-handed opening of the media supply cover 15. As shown in FIG. 15, the side of the latch member 101 facing the media support assembly 45 includes a pair of catch hooks 116 and a pair of outwardly sloped cam surfaces 117. The catch hooks 116 are configured to engage the similarly shaped flanges 100 on the platen frame 99 and, under the bias from the latch spring 103, hold the cover shut until the bias from the latch spring is overcome by depressing the latch button 28.

The outwardly sloped cam surfaces 117 are positioned to engage and urge the similarly sloped back sides of the flanges 100 on the platen frame 99 in an upward direction. Such urging helps to overcome bias against opening of the media supply cover 15, such as the weight of the platen assembly 95 and the media supply cover and friction between the biased thermal printing interface 85 and the rubber coated platen bar 96. In addition, the urging of the outwardly sloped cam surfaces 117 may be aided by the springs 79 of the print head assembly 43 urging the thermal printing interface 85 against the platen bar 96.

Opening is also inhibited somewhat by the shape of the journal notches 61 defined by the side flanges 52 of the frame 50. In particular, the intersection between the circular inner portion and flared outer portion of the journal notches 61 forms a shoulder that inhibits movement of the platen shaft 97 somewhat from the circular inner portion to the flared outer portion during opening of the media supply cover 15, as shown in FIG. 11. In addition, as the media supply cover 15 moves upwardly its motion is aided by the torsion spring 58 which has a sufficient bias to complete movement of the media supply cover into the open position after opening is initiated, as shown in FIGS. 2 and 6.

It should be noted that other shapes of cam surfaces 117 could be used to urge the media supply cover 15 upwards, and includes various surfaces with outwardly directed components. For instance, various sloped and curved shapes could be used in lieu of the linear ramp shape of the of the outwardly sloped cam surfaces 117 of the illustrated embodiment. As another alternative, the latch member 101 could be combined with other biasing devices that are activated after unlatching and provide an initial bias to the media supply cover 15. For instance, the latch member 101 could include its own compression spring that is released upon movement of the latch member to the unlatched position. Generally therefore, the present invention includes biasing of the media supply cover 15 combined with unlatching to facilitate one handed opening of the media supply cover.

During replacement of the media supply roll 54, the user pushes the latch button, 28 against the bias of the latch spring 103, which slides the latch member 101 inward and disengages the catch hooks 116 from the flanges 100 on the platen frame 99 supported by the media supply cover 15. At this point, the supply cover 15 is no longer locked down, but the torsion spring 58 provides insufficient bias to urge the media supply cover upwards against its own weight and the friction between the rubberized coating on the platen bar 96 and the thermal printing interface 85. At the same time, the tracking peg 105 is sliding along the straight portion of the engagement opening 112, as shown in FIG. 8.

After the catch hooks 116 have been disengaged, further compression of the latch button 28 engages the outwardly sloped cam surfaces 117 with the back sides of the flanges 100. As the flanges extend upward along the cam surfaces 117, the media supply cover 15 is urged upward, until the platen bar 96 is off of the thermal printing interface 85. Due at first to the bias of the torsion spring 58 and the bias from the cam surfaces 117, and eventually just the bias of the torsion spring when the media supply cover 15 has moved out of range of the latch member 101, the media supply cover 15 swings into the open position, as shown in FIG. 2.

At about the same time, the tracking peg 105 moves into the angled portion of the engagement opening 112 and urges the locking plate 102 upwards between the locking plate guides 110, thereby disengaging the locking plate teeth 111 from the teeth on the locking face 74 of the adjacent rack arm 70, as shown in FIG. 13. Disengagement of the teeth 74, 111 allows relative motion between the racks 65. The user can then reach in and retrieve the empty media supply roll 54. As the media supply roll is pulled the media support discs 63, disc support flanges 64 and the racks 65 are pushed apart against the bias exerted by the tension spring 73, allowing removal of the media supply roll with a single hand.

Placement of the new media supply roll 54 includes inserting the media supply roll between the media support discs 63 with one hand, pushing the media support discs apart against the tension spring 73. During insertion, the media support discs 63 remain centered (but could also right or left justify, or not justify at all, the media roll) due to the rotation of the pinions 72 which ensures coupling of the sliding motion of the racks 65. Once the ends of the media supply roll 54 are mounted within the edges of the media support discs 63, the user uses the same hand to push the media supply cover 15 closed against the bias of the torsion spring 58. Once the media supply cover 15 is nearly closed, the platen bar 96 pushes the thermal printing interface 85 back against the springs 79. As this occurs, the ends of the flanges 100 on the platen frame 99 intersect the tops of the catch hooks 116, sliding the latch member 101 against its bias from the latch spring 103 back into the configuration shown in FIG. 15.

Sliding of the latch member 101 also moves the tracking peg 105 from the angled portion of the engagement opening 112 in the locking plate 102, as shown in FIG. 13, into the straight portion of the engagement opening, as shown in FIG. 8. Movement into the straight portion causes the locking plate to slide within the locking plate guides 110 until the teeth 111 on the locking plate engage the teeth on the locking face 74 of the rack arm 70, thereby locking the racks 65 and the media support discs 63 in place.

The present invention has many advantages. The combined lid biasing and latching mechanism biasing allows for one-handed opening of the media supply cover 15 and replacement of the media supply. The initial bias of the latch member 101, the springs 79 of the print head assembly and the torsion spring 58 urge the media supply cover away from the rest of the housing 12 during an initial stage when the weight of the supply cover and platen assembly are at their largest. However, the initial bias from the print head springs and the latch member stop at a second stage so that only the torsion spring 58 smoothly, and relatively slowly, completes opening of the media supply cover door. Notably, therefore, the torsion spring 58 may be constructed of a relatively lightweight and inexpensive spring material that need not have a large spring constant. Use of a latching mechanism that locks the media supply in place when the media supply cover is closed ensures that the media will be secure. Securing the media by engaging the locking surface external to the opposing surfaces of the media support arms enables a more compact assembly, which is particularly useful for hand held printers. Use of multiple pinions between rack surfaces on the media support arms facilitates centering of newly placed media supply rolls.

Many modifications and other embodiments of the inventions set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A printer assembly comprising:
a housing having a media container portion and a lid configured to mate with the container portion in a closed and latched position so as to at least partially enclose media; and
a multi-stage lid opening arrangement coupled between the container portion and the lid and configured such that a first stage action frees the latched lid from the container and initiates the opening of the lid followed by a succeeding stage which continues the lid opening action.

2. A printer assembly of claim 1, wherein the multi-stage lid opening arrangement includes first stage and succeeding stage biasing devices, wherein the first stage biasing device is configured to at least partially initiate the first stage action and wherein the succeeding stage biasing device is configured to complete the succeeding stage.

3. A printer assembly of claim 2, wherein the first stage biasing device includes a spring loaded print head and a latching mechanism both configured to urge the lid away from the container portion during the first stage action.

4. A printer assembly of claim 3, wherein the succeeding stage biasing device includes a spring configured to urge the lid away from the container portion during both the first and succeeding stages.

5. A printer assembly of claim 4, further comprising a hinge rotatably connecting the lid to the container portion.

6. A printer assembly of claim 2, wherein first stage biasing device is configured to end biasing of the lid away from the container portion at the end of the first stage and wherein the succeeding stage biasing device is configured to operate during the first and succeeding stages so that the lid is opened slowly in the succeeding stage.

7. A printer assembly for dispensing a media and printing on the media as it is dispensed, the printer assembly comprising:
a housing having a container portion and a lid portion configured to mate with the container portion in a closed position so as to at least partially enclose the media;
a lid biasing device configured to partially urge the lid portion away from the container portion; and
a latching mechanism configured to, upon activation, additionally urge the lid portion away from the container portion wherein combined urging of the lid biasing device and the latching mechanism causes the lid to move to an open position revealing the media.

8. A printer assembly of claim 7, further comprising a media dispenser configured to dispense the media, a print head configured to print on the media as it is dispensed and a platen configured to hold the media against the print head, said housing at least partially supporting the print head and the media dispenser.

9. A printer assembly of claim 8, further comprising a print biasing device configured to urge the platen and the print head together, wherein said lid portion is coupled to the platen so that the print biasing device also at least partially biases the lid portion open in combination with the lid biasing device.

10. A printer assembly of claim 9, wherein the lid portion is rotatable with respect to the container portion and wherein the lid biasing device and the latching mechanism urge the lid portion to rotate into the open position.

11. A printer assembly of claim 10, wherein the lid portion is connected to the container portion with a hinge and wherein the lid biasing device is a torsion spring.

12. A printer assembly of claim 7, wherein the latching mechanism includes a cam surface configured to urge the lid portion away from the container portion.

13. A printer assembly of claim 12, wherein the cam surface is an outwardly directed, sloped surface configured to intersect and urge the lid portion away from the container portion.

14. A printer assembly of claim 7, wherein the latching mechanism is further configured to engage the lid portion and lock the lid portion closed.

15. A printer assembly of claim 14, wherein the latching mechanism includes a movable latching member having at least one latch hook and wherein the lid portion includes at least one flange, said hook being configured to engage the flange in a locking position holding the lid portion closed and the latching member movable so as to disengage the latch hook and the flange.

16. A printer assembly of claim 15, wherein the latching mechanism further includes a latch spring configured to bias the latching member into the locking position.

17. A printer assembly of claim 16, wherein the latching member includes a cam surface configured to urge the lid portion away from the container portion.

18. A printer assembly of claim 17, wherein the cam surface is positioned on the latching member so as to engage the flange of the lid portion after the latching member is moved out of the locking position against the latch spring.

19. A printer assembly of claim 18, wherein the latching member includes a sensor arm configured to trigger a sensor upon movement of the latching member out of the locking position, said sensor configured to interrupt printing by the print head in response to triggering.

20. A printer assembly of claim 14, further comprising a media dispenser configured to dispense the media, a print head configured to print on the media as it is dispensed and a platen configured to hold the media against the print head, said housing at least partially supporting the print head and the media dispenser.

21. A printer assembly of claim 20, wherein the latching mechanism is configured to lockingly engage the media dispenser so as to secure the media therein upon movement of the latching member into the locking position.

22. A printer assembly of claim 21, wherein the media dispenser includes media support members configured to move relative to each other and to grip the media therebetween and wherein the latching mechanism is configured to engage at least one of the media support members and inhibit movement of the media support member.

23. A printer assembly of claim 22, wherein the media support member includes a locking surface and wherein the latching mechanism includes a locking surface configured to engage the locking surface of the media support member.

24. A printer assembly of claim 23, wherein the latching mechanism includes a latch member and a locking plate, said latch member configured to engage the lid portion in a locking position and said locking plate including the locking surface and movably coupled to the latch member so as to engage the locking surface with the locking surface of the media support member when the latch member is moved into the locking position.

25. A printer assembly for dispensing a media from a media supply and printing on the media as it is dispensed, the printer assembly comprising:
a housing having a container portion and a lid portion configured to mate with the container portion in a closed position so as to at least partially enclose the media;
media support members configured to grip the media supply when the media supply is positioned between the media support members;
a media dispenser configured to dispense the media from the media supply while held between the media support members;
a print head configured to print on the media as it is dispensed;
media support arms, wherein each of the support arms supports a respective one of the media support members, wherein the media support arms are movable relative to each other so as to urge the media support members together to grip the media supply and wherein at least one of the media support arms has a locking surface positioned external to opposing, relatively moving surfaces of media support arms; and
a latch mechanism supported by the housing, having a locking surface and movable to at least partially secure the lid in the closed position, wherein said latch mechanism is configured to engage the locking surfaces upon moving to secure the lid in the closed position and wherein engagement of the locking surfaces restricts relative movement of the media support arms and media support members so as to secure the media between the media support members.

26. A printer assembly of claim 25, further comprising at least one pinion, wherein the support arms include racks, each of the racks disposed on one of the opposing, relatively moving surfaces of each of the support arms and wherein the pinion is positioned between and configured to couple movement of the racks and the support arms.

27. A printer assembly of claim 26, wherein the locking surface on the support member is positioned opposite the rack on the support member.

28. A printer assembly of claim 27, wherein the latch mechanism includes a latch member and a locking plate, wherein the locking plate supports the locking surface of the latch mechanism and wherein the locking plate is configured to move relative to the latch member.

29. A printer assembly of claim 28, wherein the latch member includes at least one latch hook and wherein the lid portion includes at least one flange, said latch member being movable to engage the latch hook with the flange and secure the lid portion in the closed position.

30. A printer assembly of claim 29, wherein one of the locking plate and the latch member includes a cam surface configured to urge the locking surface of the locking plate into engagement with the locking surface of the support member.

31. A printer assembly of claim 30, wherein one of the locking surfaces has concave teeth and the other of the locking surfaces has convex teeth configured to mate with the concave teeth.

32. A printer assembly of claim 31, wherein the latch member includes locking plate guides and wherein the locking plate is positioned between and slides relative to the locking plate guides.

33. A printer assembly of claim 32, wherein the cam surface is defined by an engagement opening of the locking plate and wherein the latch member includes a tracking peg extending into the engagement opening.

34. A printer assembly of claim 33, wherein the engagement opening includes a straight portion and an angled portion and wherein sliding movement of the latch member into the locking position moves the tracking peg from the straight portion into the angled portion and wherein movement into the angled portion urges the locking surface of the locking plate into engagement with the locking surface of the support member.

35. A printer assembly of claim 34, wherein the latching mechanism further includes a latch spring configured to bias the latch member into the closed position.

36. A media support assembly for centering and holding a media supply, said media support assembly comprising:
media support members configured to grip the media supply when the media supply is positioned between the media support members;
a media dispenser configured to dispense the media from the media supply while held between the media support members;
media support arms, wherein each of the support arms supports a respective one of media support members and includes a rack surface, and wherein the support arms are movable with respect to each other so as to urge the media support members together to grip the media supply; and
at least two pinions mounted between the support arms, a first one of the pinions meshing with the rack surface of one of the media support arms, and a second one of the pinions, the second one of the pinions meshing with the rack surface of the other one of the media support arms, wherein the pinions couple motion of the support arms and the media support members so that the media support members are self centering when gripping the media supply therebetween.

37. A media support assembly of claim 36, further comprising a third pinion meshing with the first and second pinions.

38. A media support assembly of claim 36, further comprising a latching assembly including a locking surface, wherein the support arms include opposing, relatively moving surfaces and wherein one of the support arms includes a locking surface positioned external to the opposing surfaces on the support arms and wherein the locking surface of the latching assembly is configured to engage the locking surface on the support arm and restrict motion between the support arms and the media support members.

39. A media support assembly of claim 38, further comprising a housing having a container portion and a lid portion configured to mate with the container portion in a closed position so as to at least partially enclose the media and wherein said latching assembly is configured to engage the lid portion in a closed position when engaging the locking surfaces.

40. A method of opening a lid portion of a printer housing holding a media, said method comprising:
disengaging the lid portion from a container portion of the printer housing by activating a latching mechanism configured to at least partially bias the lid portion away from the container portion; and
completing opening of the lid portion using a lid biasing device and revealing the media supply.

41. A method of claim 40, wherein completing opening of the lid portion includes rotating the lid portion with respect to the container portion using a torsion spring.

42. A method of claim 41, wherein disengaging the lid portion and completing opening of the lid portion includes overcoming biasing of a platen of the lid portion against a print head supported in the container portion.

43. A method of claim 40, wherein disengaging the lid portion includes urging a cam surface of the latching mechanism against the lid portion.

44. A method of claim 43, further comprising disengaging a latch hook of the latching mechanism from a flange of the lid portion when activating the latching mechanism.

45. A method of claim 44, further comprising unlocking a media support assembly to allow removal of the media therefrom when activating the latching mechanism.

46. A method of locking media in place inside a printer housing, said method comprising:
gripping the media between a media support members by biasing together media support arms supporting the media support members, wherein said media support members include opposing, relatively movable surfaces; and
engaging a locking surface of a locking mechanism with a locking surface positioned on one of the media support arms external to the opposing, relatively movable surfaces so as to restrict motion between the media support arms and the media support members, wherein the media supply is locked in place between the media support members.

47. A method of claim 46, further comprising centering the media support members by allowing relative motion between the media support members via a rack on each of the media support members and at least one pinion configured to couple motion of the racks.

48. A method of claim 47, wherein engaging the locking surfaces includes engaging the locking surface of the media support member in a position opposite the rack of the media support member.

49. A method of claim 48, wherein engaging the locking surfaces includes sliding a latching member of the locking mechanism to lock a lid of the housing in a closed position and engaging a cam surface of the latching member with a locking plate of the locking mechanism supporting the locking surface of the locking mechanism.

50. A method of claim 49, wherein sliding the latching member engages a latch hook of the latching member with a flange of the lid to lock the lid of the housing.
